(19) United States
(12) Patent Application Publication
(10) Pub. No.: US 2012/0140300 A1
(43) Pub. Date: Jun. 7, 2012

(54) DISPLAY SYSTEMS INCORPORATING FOURIER OPTICS

(75) Inventor: Jonathan Paul Freeman, Cambridgeshire (GB)

(73) Assignee: BAE SYSTEMS PLC, London (GB)

(21) Appl. No.: 13/389,707

(22) PCT Filed: Aug. 10, 2010
(86) PCT No.: PCT/GB10/51320

§ 371 Date: Feb. 9, 2012

(30) Foreign Application Priority Data
Aug. 13, 2009 (GB) 0914176.3
Aug. 19, 2009 (EP) 09275062.9

(51) Int. Cl. G03H 1/08; G03H 1/22

(52) U.S. Cl. 359/9; 359/13; 359/14

(57) ABSTRACT

A head up display signal processing system is disclosed. The system comprises an image projector for projecting an image onto a screen, the screen being partially reflective and partially transmissive. The system is operable to provide a separate optical element at a plurality of locations upon the screen, wherein each element comprises an optical phase representative of the location of the element upon the screen, such that the combination of optical elements is arranged to produce an optical hologram upon the screen.

### FIELD OF THE INVENTION

The present invention relates to display systems incorporating Fourier optics and particularly, but not exclusively to head-up displays and head mounted displays as used by personnel in, for example, medicine, the emergency services, the military and virtual reality garners for providing hands-free visual data.

### BACKGROUND TO THE INVENTION

A head-up display, or HUD, is any transparent display that presents data without requiring the user to look away from his or her usual viewpoint. The origin of the name sterns from the user, for example a pilot within a cockpit of an aircraft being able to view information with their head “up” and looking forward, instead of angled down looking at lower instruments situated within a cockpit. Although they were initially developed for military aviation, HUDs are now used in commercial aircraft, automobiles, and other applications.

There are two types of head-up display: fixed head-up displays and helmet mounted displays. Fixed head-up displays require a user to look through a display element attached to an airframe or a vehicle chassis. The system determines the image to be presented depending solely on the orientation of the vehicle. Helmet or head mounted displays (HMD) feature a display element that moves with the orientation of the user's head with respect to, for example, an airframe. Many modern fighters (such as F/A-18, F-22 & Eurofighter) use both a HUD and an HMD concurrently.

A typical HUD for an aircraft is arranged to project an image onto a face of a partially transmissive/partially reflective screen element such as a transmissive combiner or optical image combiner of the cockpit windshield. A typical HMD has either one or two small display units with lenses and semi-transparent mirrors embedded in a helmet, eye-glasses or visor, for example. The display units are miniaturized and may include one or more Cathode Ray Tubes (CRT), Liquid Crystal Digital (LCD) or other types of planar display.

A display unit will provide images of various symbols for the representation of information generated by an electronic computer. From the image source, namely the display unit, light rays will travel through an optical system onto a combining element situated in the pilot's field of view, either on a helmet or interposed between the pilot's head and the front of the wind screen. The combining element is arranged to transmit real world images and reflects images by means of collimated light into the pilot's eyes.

Due to the increasing complexity of aircraft instrumentation, pilots have been burdened with numerous monitoring activities, even during normal operations. Flight information from the cockpit instruments will typically include many discrete items of data which need to be checked repeatedly, such as, torque, altitude, heading, attitude etc. However, when flying in an operational mode, a pilot cannot afford to divert his attention to any in-cockpit instrument, lest he be surprised by an unexpected obstacle or threat in his path.

Simply, an HMD projects head-directed sensor imagery and/or fire control symbology onto the eye, and is usually superimposed over a transparent screen. As such, HMDs offer the potential for enhanced situation awareness and effectiveness. However, the design and implementation of developments are not without problems and limitations. The HMD is arranged to provide a projected hologram onto a visor, for example, which acts as an optical image combiner. Of the potential problems with HMDs, one issue is that of optical aberration errors arising from the image being received upon a curved visor. The image can be generated using a Fourier transform (FT) of that image, and displaying the resultant diffractive pattern on a suitable device such as a spatial light modulator (SLM) which is illuminated in a suitable manner and which is capable of modifying phase. Some of the aberrations in the optical system comprising the SLM, can also be inverted and encoded into a holographic diffractive pattern and combined with the FT of the image so that the system as a whole produces a nominally un-aberrated image. However, error correction using Fourier analysis by employing a single correction computer generated hologram is limited, since the spatial light modulator is effectively at the end of the optical system. As a result, it can be very difficult to correct for field curvature.

Presently, error correction in a computer generated holograms is effected by the use of a phase correction hologram accompanied with a phase hologram, where a continuous correction phase is determined, for example by using conventional polynomial expression or breaking it down into Zernike polynomials. However, whilst the hologram can be optically corrected, all the field angles become corrected at once; that is to say, for any final image such as a landscape view, then the correction hologram will correct for all aspects of the whole image. For example, in situations where there is field curvature so that the centre of the image is in focus but the edge is out of focus, then it is difficult to correct for this curvature using a correction hologram, because in adding a correction hologram to focus the edge, the centre becomes out of focus. Whilst the errors are more noticeable with HMDs, similar diffraction issues will arise with HUDs, especially where the image impinges upon a curved surface.

### OBJECT TO THE INVENTION

The present invention seeks to provide an improved display system incorporating Fourier optics that is operable to overcome errors arising from aberration in an optical system. The present invention also seeks to provide an improved head-up display and particularly, but not exclusively, an improved helmet mounted display system. The present invention also seeks to provide a display system which can operate with curved imaging optics such as windscreens and helmet visors.

### SUMMARY OF THE INVENTION

In accordance with a first aspect of the present invention, there is provided a head up display signal processing system, the system comprising an image projector for projecting an image to a screen, the screen being partially reflective and partially transmissive, the system being operable to provide a separate optical element at a plurality of locations upon the screen, wherein each element comprises an optical phase representative of the location of the element upon the screen, such that the combination of optical elements is arranged to produce an optical hologram upon the screen.

Preferably, the screen is substantially non-planar.

Ordinarily, for example in a helmet mounted display system, error correction is problematic when a single correction computer generated hologram is encoded in a spatial light modulator; the spatial light modulator is effectively at the stop of the system and accordingly a single correction cannot be implemented where aberrations such as field curvature are present. In contrast and in accordance with the invention, the provision of a different holographic element for all field positions enables errors arising from curvature in a field, for example due to a curved visor, to be overcome.

Preferably, the optical elements are generated using a spatial light modulator, and more particularly an Electrically Addressed Spatial Light Modulator (EASLM).

Preferably, the image projector comprises a cathode ray tube for generating the image and projecting the image onto the screen. Alternatively, the image projector comprises a flat panel display, such as a liquid crystal display for generating the image and projecting the image onto the screen. The correction holograms are incorporated with the FT of the video image onto the same SLM.

The image projector is preferably arranged to communicate with a transmitting device, such as a sensor for receiving image data to be presented by the system. Preferably, the image projector communicates with the transmitting device via a cable that electrically couples the image projector to the transmitting device.

The image projector preferably comprises a wireless receiver for receiving wireless data from a transmitting device.

In a helmet mounted display including such a signal processing system it will be appreciated that, for example, flight critical information must always be visible and capable of being read. The present invention thus provides an appropriate holographic element to take into account diffraction angle induced errors.

In a vehicular mounted head-up display system including such a signal processing system, the system can prevent or reduce the likelihood of errors in reading image information arising from diffraction angle induced errors.

In accordance with a further aspect of the invention, there is provided a method of operating a signal processing system, the system comprising a spatial light modulator, an image projector for projecting an image onto a screen, the screen being partially reflective, partially transmissive and further comprising a substantially non-planar section,

the method comprising the step of operating the spatial light modulator to generate separate optical images at a plurality of predefined locations on the screen, wherein each element comprises an optical phase representative of the location of the element upon the screen, such that the combination of optical elements is arranged to produce an optical hologram upon the screen.

The overall goal of head-up display and helmet mounted displays is to effectively interface the user with his surroundings, be it an aeroplane, a fellow crewmember in a search and rescue team, or a games console and video screen. In one embodiment, the present invention provides a head mounted device which, using simple optical devices, enables optical aberration issues arising from curved visors and the like to be overcome.

### BRIEF DESCRIPTION OF THE FIGURES

Reference shall now be made to the Figures as shown in the accompanying drawing sheets, wherein:

FIG. 1 shows a display system of a known head mounted device;

FIG. 2 illustrates light ray paths in a head mounted device made in accordance with the invention; and,

FIG. 3 illustrates process steps in the generation of signals input to a device to produce a different holographic optical element for all field positions.

### DETAILED DESCRIPTION OF PREFERRED EMBODIMENT

There will now be described, by way of example only, the best mode contemplated by the inventor for carrying out the present invention. In the following description, numerous specific details are set out in order to provide a complete understanding to the present invention. It will be apparent to those skilled in the art that the present invention may be put into practice with variations of the specific.

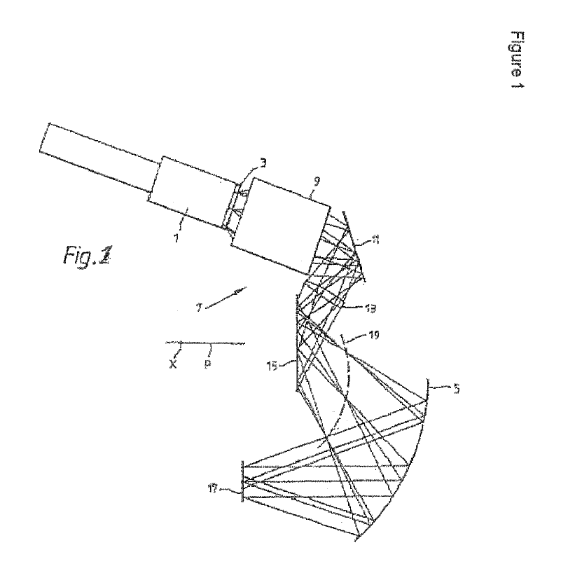

For simplicity, the present invention shall be generally described in relation to a head mounted display, although the same principles apply to other Fourier projections. Referring now to a FIG. 1, there is shown a prior art CRT head mounted display system. The display system is a binocular system and utilises two Fourier display systems (only one of which is shown in FIG. 1), one for each eye of a user of the system.

The display system for each eye comprises a miniature cathode ray tube (CRT) 1 comprising a screen 3. The image to be presented to the wearer of the helmet (not shown) is produced at the screen 3. This image is passed through an optical arrangement of lenses and mirrors and superimposed on a curved or otherwise substantially non-planar visor 5, mounted on the helmet.

Light rays from the screen 3 pass first through a relay lens arrangement 7 comprising a lens group 9, a plane fold mirror 11, and a lens 13. Light rays exiting the lens 13 are directed in a general rearward and downward direction towards a forwards facing plane mirror 15 mounted at a central brow position on the helmet (not shown), i.e. centrally above the helmet face aperture. The mirror 15 is disposed in a generally vertical plane so as to reflect the light rays forwards and downwards, toward a region of the internal, concavely curved surface of the visor 5, for reflection thereat to the left or right eye position 17 of the helmet wearer.

The lens arrangement 7 and lens 13 are positioned and designed to produce a real image of the display on the screen 3 at the principal wavefront 19 of the concave reflecting surface constituted by the internal surface of the visor 5, which image contains equal and opposite optical aberrations to those produced by subsequent reflection at the visor 5. Due to the close proximity of the wavefront 19 to the eye position 17, the wearer of the helmet is provided at each eye with a large instantaneous field of view of a collimated virtual image of the display on the screen 3, superimposed on the forward scene viewed through the visor 5.

As is apparent from FIG. 1, the optical axis of the optical system lies in a plane. This plane is arranged to contain the centre of curvature X of the visor 5. As a result, whilst the light rays reflected at visor 5 are subject to off-axis aberration in the plane of the optical axis, the light rays are on-axis in planes orthogonal to the optical axis plane. It will be appreciated that whilst depicted as geometrically flat in FIG. 1, the plane is in fact folded by the mirror 11. The purpose of the mirror 11 is to allow the components of the system, more particularly the lens group 9 and CRT 1, to be positioned closely around the head of the helmet wearer. A brow mirror 15 is also placed to redirect the images from mirror 11. The mirror 15 is accurately positioned upon a frame (not shown) so that it can be secured with respect to the helmet (not shown). The visor 5 can also conveniently be pivotally mounted with respect to the frame (not shown).

To correct for any rotation of the images of the display that are presented to the helmet wearer as the optical planes are rotated relative to each other, the images of the display as presented on the CRT screens 3 are rotated electronically between different pre-settable positions. Electronic correction of other undesired minor differences in the display in the different pre-settable positions, e.g. in bore-sight alignment between the different positions, may also be effected electronically. The required electronic corrections may be determined empirically and stored in a look-up table.

In a typical aviation scenario, an external scene is acquired by a sensor, converted into an electrical signal, reproduced on a display, and then relayed optically to the eye(s). Within our definition of an HMD, the display which first reproduces the scene imagery, prior to relaying it to the eye, is referred to as the image source. When the concept of HMDs was first seriously pursued, the CRT was the only established display technology available. CRTs have remained the display of choice due to their attributes of low cost, easy availability, dependability, and good image quality. Flat panel displays (FPDs) have a greatly reduced physical profile, low power and voltage requirements, low heat output, and low weight. All of these characteristics make them very desirable for aviation use where space, weight, and power are at a premium.

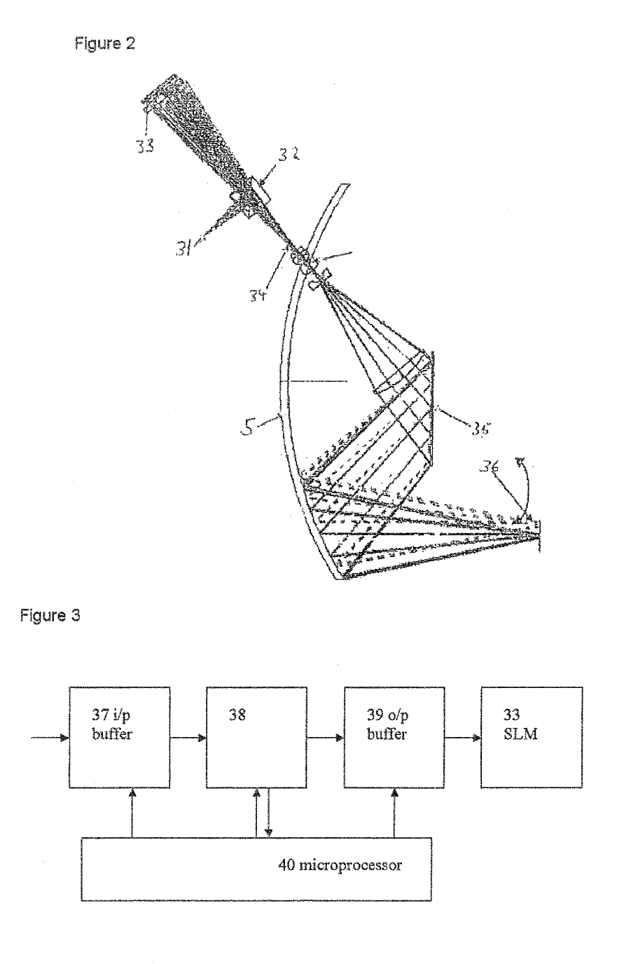

Referring now to FIG. 2 of the drawings, there is shown a schematic view of a helmet mounted display according to an embodiment of the present invention. A diffraction limited laser source 31 is provided and directed towards a polarising beam-splitter cube 32, which reflects the beam onto a spatial light modulator 33. The SLM 33 is configured to provide image information which is contained in the laser radiation reflected from the SLM 33. The reflected radiation is arranged to pass through the cube 32 and is focussed by optical path elements 34 onto a pivoting brow mirror 36.

Referring now to FIG. 3 of the drawings, there is shown a flow diagram of the components of a data input flow for a spatial light modulator 33. Data from one or more sensors (not shown) which is to be displayed as an image on the HMD, is fed into an input buffer 37, which under the control of micro-processor unit 40, outputs image frame data, namely data acquired during a period of time known as the frame period, to a holographic processor unit 38. The holographic processor 38 phase modulates the image frame data and subjects the same to Fourier processing and quantisation. The processed image data corresponding to a particular frame period is then transferred to an output buffer 39 and subsequently to the SLM 33, as a series of discrete packets of sub-frame data.

The input to the system of FIG. 3 is preferably image data from the relevant system monitors (not shown). The input buffer 37 preferably comprises dual-port memory such that data is written into the input buffer and read out from the input buffer simultaneously. The data corresponding to the sub-frames is outputted from the output buffer 39 and supplied to SLM 33 or other suitable display device.

Reference shall now be made to the mathematical optical processes, as follows: For a phase SLM with X×Y pixels and a video image frame containing U×V pixels then a resultant video image would be of the form

video frame=I_{u,v}

where 1≦u≦U and 1≦v≦V and u, v are the integer coordinates of pixels within the video frame and I is the intensity at u,v.

Normally random phase is taken into account by the addition of such to the amplitude of the video frame and a Fast Fourier Transform (FFT) is taken of the complex video frame.

Accordingly:

complex amplitude A^{c}={square root over (I_{u,v}e^{jφ}^{_{u,v}})}

where φ_{u,v} is a uniformly distributed random phase between 0 and 2π at coordinates u and v.

If the complex hologram is:

complex hologram=H^{C}_{x,y}

where H^{C}_{x,y} is the phase and amplitude of the hologram at its coordinates x,y and 1≦x≦X and 1≦y≦Y, then:

H^{C}_{x,y}=F⁻¹A [1]

where F⁻¹ represents the inverse Fourier transform.

The phase hologram is given by

H_{x,y}=□H_{x,y}^{C} [2]

The random phase given to the amplitude distributes the bandwidth within the computer generated hologram (CGH).

A phase correction hologram may be combined with the hologram above in accordance with accepted techniques. In the first instance, a continuous correction phase is determined using a conventional polynomial expression or breaking it down into Zernike polynomials or a combination i.e.

P_{x,y}=P_{x1,y1}+P_{x2,y2} . . .

These are then made complex and multiplied by the complex form of the CGH in [1] to give the corrected CGH

Hcorr_{x,y}^{C}=H_{x,y}^{C}*P_{x,y}e^{jφ}

The phase is then taken to give the corrected CGH hologram.

Hcorr_{x,y}=□Hcorr_{x,y}^{C}

By this method, the hologram can be optically corrected—but only using one correction hologram for all the field angles at once. If there is a holographic system that produces a final image such as a holographic video projector then a correction hologram will correct the whole image. For example, if there is a situation where field curvature affects the view such that the centre of the image is in focus but the edge is out of focus, then this method cannot correct for this error since by providing a correction hologram to focus the edge, then the centre view will become out of focus.

A computer generated hologram of a video image can be split. For each pixel, the computer generated hologram will comprise a real part comprising a sawtooth grating whose frequency and direction are dependent on the position of the pixel. Accordingly, all the pixels of a video image can be converted separately. If a combination of these sawtooth gratings is made by adding the complex form, then the result is the same as if the computer generated hologram had been created directly using, for example, a fast Fourier transform.

The separate sawtooth gratings can be combined with a correction hologram designed to correct particular pixels. Thus, in relation to the example above, the focus at the edge of the image can be corrected without affecting the focus of the centre pixels; indeed, all those pixels in-between can also be corrected by an appropriate amount.

The present invention can be realised in a slightly different fashion, where instead of calculating a sawtooth grating for each pixel, the same can be represented as a continuous real phase. This can be considered as being the equivalent of “unwrapping” the sawtooth but can be calculated directly. The slope of the phase determines the video pixel position; where the phase value cuts the axis determines any phase offset. The correction phase for this pixel can be added directly to the continuous phase and the resultant wrapped into a complex form to be added up to give the final corrected CGH.

The SLM can be manufactured from a substrate that enables fast transitions to be performed such as a ferroelectric, which are known to result in images of good quality. Many different holograms of the same image can be calculated but with different start phases so that the errors can average out.

The FFT of the video image comprises a collection of complex diffraction gratings, one grating being provided per pixel position. The FFT of the video is encoded pixel by pixel whereby an appropriate holographic optical element can be applied to each pixel. Whilst this could be interpreted as requiring huge processing powers, in relation to symbology images in a HMD/HUD arrangement, the processing powers required are not too great, since the screen area occupied by the images is typically less than 5%.

It will be appreciated that for satisfactory operation of the display system the relative positions of the various components of the system have to be accurately maintained against helmet flexures arising from vibration, acceleration, donning and doffing of the helmet etc. and against temperature variations. This problem arises particularly from the fact that visors capable of surviving ejection windblast loading are made from materials such as polycarbonate which exhibit low stiffness and a high thermal coefficient of expansion.

As with most optical systems, the present invention is designed within a suitable optical design package, in this case the package must be capable of defining and optimising phase elements within the system and defining the Fourier pattern representing the video image. The phase element is placed coincident with the Fourier pattern and the optical design package allowed to optimise the phase element along with the rest of the system optics (if appropriate) to minimise the system optical aberrations to less than an appropriate level for that system. The phase element has a constraint placed on it that the correction phase and the Fourier pattern must be within the limits of what the SLM device is capable of showing. The resultant phase correction may be in the form of a conventional polynomial or a Zernike polynomial.

In the present case several field positions within the video image are converted separately and the phase mapped (usually by interpolation) and the correction phase calculated for each pixel. These are then combined separately before being finally combined into one CGH for display on the SLM.

The SLM can comprise an Electrically Addressed Spatial Light Modulator (EASLM). An EASLM can conveniently be fabricated as an LCD-based reflection EASLM. The reflective surface is the functional area. The image on an electrically addressed spatial light modulator is created and changed electronically, as in most electronic displays. The spatial light modulator is encoded such that diffraction errors are compensated for and the image viewed upon the screen is not affected by diffraction angle issues.

Application of the head up display includes most vehicles where a screen is typically placed before a driver or pilot of the vehicle, irrespective of any curvature of a screen upon which the imagery might be displayed. Application of the helmet mounted display include military, civilian law enforcement, fires-fighters, gamers and the like, where sensor imagery, for example, is required to be seen by the wearer of such a helmet, irrespective of any curvature of a visor. Where the head up display comprises a helmet mounted system, for personnel involved in, for example, search and rescues, then the micro-image projector unit can conveniently include a processor unit which includes a wireless receiver for receiving dynamic wireless media data from a transmitting device; alternatively, the micro-image projector unit communicates with a transmitting device via a cable that electrically couples the micro-image projector unit to the transmitting device.

1. A head up display signal processing system, the system comprising an image projector for projecting an image to a screen, the screen being partially reflective and partially transmissive, the system being operable to provide a separate optical element at a plurality of locations upon the screen, wherein each element comprises an optical phase representative of the location of the element upon the screen, such that the combination of optical elements is arranged to produce an optical hologram upon the screen.

2. A head up display signal processing system according to claim 1, wherein the screen is substantially non-planar.

3. A head up display signal processing system according to claim 1, wherein the optical elements are generated using a spatial light modulator.

4. A head up display signal processing system according to claim 3 wherein the spatial light modulator comprises an Electrically Addressed Spatial Light Modulator (EASLM).

5. A head up display signal processing system according to claim 1, wherein the image projector comprises a cathode ray tube for generating the image and projecting the image onto the screen.

6. A head up display signal processing system according to claim 1, wherein the image projector comprises a flat panel display for generating the image and projecting the image onto the screen.

7. A head up display signal processing system according to claim 1, wherein the image projector comprises a liquid crystal display for generating the image and projecting the image onto the screen.

8. A head up display signal processing system according to claim 1, wherein the image projector is arranged to communicate with a transmitting device.

9. A head up display signal processing system according to claim 8, wherein the image projector is arranged to communicate with the transmitting device via a cable that electrically couples the image projector to the transmitting device.

10. A head up display signal processing system according to claim 1, wherein the image projector comprises a wireless receiver for receiving wireless data from a transmitting device.

11. A head up display signal processing system according to claim 8, wherein the transmitting device comprises a sensor for receiving image data to be presented by the display system.

12. A head up display signal processing system according to claim 1 mounted within a helmet.

13. A head up display signal processing system according to claim 12, wherein the screen comprises a visor, one of or both glasses of a pair of goggles, or one of or both glasses of a pair of eye glasses.

14. A head up display signal processing system according to claim 13, wherein the goggles and/or eye glasses comprise means for securing to a user's head or helmet.

15. A vehicular mounted head up display system comprising a head up display signal processing system according to claim 1.

16. A helmet mounted display system comprising a head up signal processing system according to claim 1.

17. A method of operating a signal processing system, the system comprising a spatial light modulator, an image projector for projecting an image onto a screen, the screen being partially reflective, partially transmissive and further comprising a substantially non-planar section, the method comprising the step of operating the spatial light modulator to generate separate optical images at a plurality of predefined locations on the screen, wherein each element comprises an optical phase representative of the location of the element upon the screen, such that the combination of optical elements is arranged to produce an optical hologram upon the screen.
